(19) United States
(12) Patent Application Publication
(10) Pub. No.: US 2015/0310362 A1
(43) Pub. Date: Oct. 29, 2015

(54) Health Care Work Flow Modeling with Proactive Metrics

(71) Applicant: Poiesis Informatics, Inc., Pittsburgh, PA (US)

(72) Inventor: John Huffman, Portland, OR (US)

(73) Assignee: Poiesis Informatics, Inc., Pittsburgh, PA (US)

(21) Appl. No.: 14/643,772

(22) Filed: Mar. 10, 2015

Related U.S. Application Data
(63) Continuation of application No. 13/206,473, filed on Aug. 9, 2011, now abandoned.
(60) Provisional application No. 61/372,021, filed on Aug. 9, 2010.

(51) Int. Cl. G06Q 10/06; G06Q 50/22

(52) U.S. Cl. CPC G06Q 10/0633; G06Q 50/22

(57) ABSTRACT

A method, system and non-transitory computer readable medium for modeling and analyzing health information to optimize workflows. The method commences by collecting information in real time from a plurality of health care resources, and based on the collected information, the method develops a dynamic model of workflow that incorporates the health care resources and corresponding real time information. The method proceeds to monitor current in-flight processes of the modeled workflow to determine if a failure might occur on the current in-flight trend, and then generates a proactive metric if an impending failure was predicted. Modeling steps comprise developing a retrospective workflow model based on a historical analysis of the health care resources. The financial impact of an impending failure and the financial impacts of alternative workflows are analyzed.

### FIELD

This invention applies to the domain of healthcare, particularly to techniques for managing productivity in a healthcare environment.

### BACKGROUND

Measuring productivity in the healthcare environment is a complicated task. There are no well-defined metrics or standards, and there are several systems with independent databases and work flows that must be integrated to collect the data required for any meaningful analysis. Some of these systems are the HIS, RIS, modalities and the PACS. The problem is that these systems have evolved independently and have not been designed for interoperability. Besides the common issues of different “Health Level Seven” (HL7) dialects, many of these systems are just not designed to share their internal data except through their own user interfaces. The problem is exacerbated at large institutions when multiple different vendor versions of components are present.

Therefore, there is a need for an improved approach for measuring productivity in the healthcare environment.

Further details of aspects, objects, and advantages of the disclosure are described below in the detailed description, drawings, and claims. Both the foregoing general description of the background and the following detailed description are exemplary and explanatory, and are not intended to be limiting as to the scope of the claims.

### SUMMARY

A method, system and non-transitory computer readable medium for modeling and analyzing health information to optimize workflows. The method commences by collecting information in real time from a plurality of health care resources, and based on the collected information, the method develops a dynamic model of workflow that incorporates the health care resources and corresponding real time information. The method proceeds to monitor current in-flight processes of the modeled workflow to determine if a failure might occur on the current in-flight trend, and then generates a proactive metric if an impending failure was predicted. Modeling steps comprise developing a retrospective workflow model based on a historical analysis of the health care resources. The financial impact of an impending failure and the financial impacts of alternative workflows are analyzed.

### BRIEF DESCRIPTION OF THE DRAWINGS

FIG. 1 is a flow chart showing steps for creating and updating an operational model, according to some embodiments.

FIG. 2 depicts a system configured to aid in the practice of health care workflow modeling using proactive metrics e, according to some embodiments.

FIG. 3 depicts a system for health care workflow modeling with proactive metrics, according to some embodiments.

FIG. 4 depicts a system in which analytics solutions can be practiced, according to some embodiments.

FIG. 5 depicts a system for health care workflow modeling using an analytics server, according to some embodiments.

FIG. 6 is an illustration of a system for analyzing health care workflows using operational models, according to some embodiments.

FIG. 7 is a flow chart depicting steps in a system for health care workflow modeling with proactive metrics, according to some embodiments.

FIG. 8 depicts a block diagram of a system for analyzing health information to optimize workflows.

FIG. 9 is a diagrammatic representation of a computer network, according to some embodiments.

### DETAILED DESCRIPTION

Measuring productivity in the healthcare environment is a complicated task. There are no well-defined metrics or standards, and there are several systems with independent databases and work flows that must be integrated to collect the data required for any meaningful analysis. Moreover, in some situations administrators in healthcare environment are still asking fundamental questions such as, “What is productivity”. “How is it measured?”

And, there are some questions that arise commonly at many healthcare institutions; questions such as
What is the case throughput per day for the department, per modality, per radiologist, per procedure type?
Are there any cases that have been left unread?
What is the distribution of completion times for reports?
Who are the under- or over-performers in the institution?
What are the causes of departmental back-ups?
How should exams be assigned to improve throughput?

All of these are good questions, and can be addressed with a comprehensive, workflow-integrated analytics package. However, to improve efficiency, one needs a baseline to compare against, and a target efficiency goal to aim for.

Baseline sets of processes usually evolve over time as individuals or departments adjust their procedures to address new requirements. At more advanced institutions, there can be rudimentary tracking of individual procedures against this designed workflow to determine if a particular metric, threshold or service level agreement (SLA) has been violated. Only a few institutions have designed integrated sets of procedures to govern the work performed across departmental boundaries, and fewer still—if any—have automated any of the processes.

If a healthcare institution actively uses its established workflow, then it is not difficult to determine if a particular process or procedure followed if the respective workflow had met expectations. For example, if an emergency room patient had a set of x-rays made, it can be measured to determine if the x-rays and corresponding report was returned within a specified period of time. The problem with this approach is that there is no a priori way to determine if this is an optimal process, or even to measure the effectiveness of the process against other options.

How can a healthcare institution measure productivity? One can evaluate how current processes adhere to specified workflow, but how can an institution determine if one workflow is better than another—how does one improve workflow to increase productivity, without compromising patient care, of course.

Measuring and improving productivity in the healthcare environment is complicated. There are no well-defined metrics or standards, and there are many systems with independent databases and workflows that must be integrated to collect data needed for any meaningful analysis. Some of these systems are the HIS (Hospital Information System), RIS (Radiology Information System), modalities (CT, X-Ray, MR, etc.) and the PACS (Picture Archive and Communication System). One problem to solve is that these systems have evolved in the healthcare environment independently and have not been designed for interoperability. Besides the common issues of different HL7 dialects, many of these systems are not designed to share their internal data except through their own (e.g. proprietary) user interfaces. The problem is exacerbated at large institutions when multiple vendor versions of similar components are present introducing a whole layer of additional incompatibilities and data synchronization issues. These considerations do not even address the variability in skill or efficiency introduced by different human resources and their interaction with the information systems.

Embodiments of the systems disclosed herein can be configured to consume virtually any available data feed from information sources within a healthcare institution, parse and normalize the data pertinent to workflow and file the data, or a reference to the data location, in one or more databases. The system can further be configured to perform analysis based on real-time and/or retrospective information to characterize the current, or historical behavior or performance of any resource or set of resources in the healthcare institution.

One function of the systems described herein is to maintain a dynamic model of the workflow in use at a healthcare institution and actively monitor the underlying processes to determine the system performance relative to the expected norm and to infer if there is an impending failure in expected performance or predict any deviation from an SLA (service level agreement). Another function of the systems described herein is to perform analysis of the financial impact of an impending failure.

Legacy techniques merely provide metrics for how productive a resource is/was, or merely report or flag and event that a failure has occurred. The problem with this legacy approach is that the reported failure had already occurred.

What is needed are real-time models of the current in-flight processes that are actively monitored against the continuously updated models of specific workflows in order to determine whether the current performance is degraded from the expected norm and whether the current inputs to the system are likely to cause a failure in expected workflow.

Being aware that there has been a failure in a system is of some use however, inferring or predicting that a failure is impending or imminent is of tremendous value, especially if the prediction is made early enough in time to correct the system before the predicted failure occurs. The value can be cast both in terms of productivity, and in terms of quality patient care.

In the disclosure herein, this is referred to as a “proactive metric”. The system consumes these proactive metrics to either indicate to an external agent, or to automatically adjust work assignment or workflow to prevent inferred workflow failures. In addition, the dynamic monitoring of real-time inputs to the disclosed systems enables the systems to diagnose system degradation and identify specific causes of degradation.

The herein disclosed techniques include a system to monitor all in-flight workflows, their current status, and all resources in use, or anticipated to be in use. By using the retrospective analysis of the contributing resources, an expected performance can be tracked. Any deviation from the anticipated behavior can be signaled based on the severity. This deviation can range from a detected “slow down” that might not cause any violation of an SLA, to an inference that the degradation in performance (if uncorrected) would cause an imminent failure to achieve an SLA. These events (e.g. deviation from the anticipated behavior) can be presented to an administrator or other monitoring resource, or in more sophisticated systems, could cause an automatic re-direction of scheduled work in order to prevent any SLA failure. Further use cases are presented in a later section.

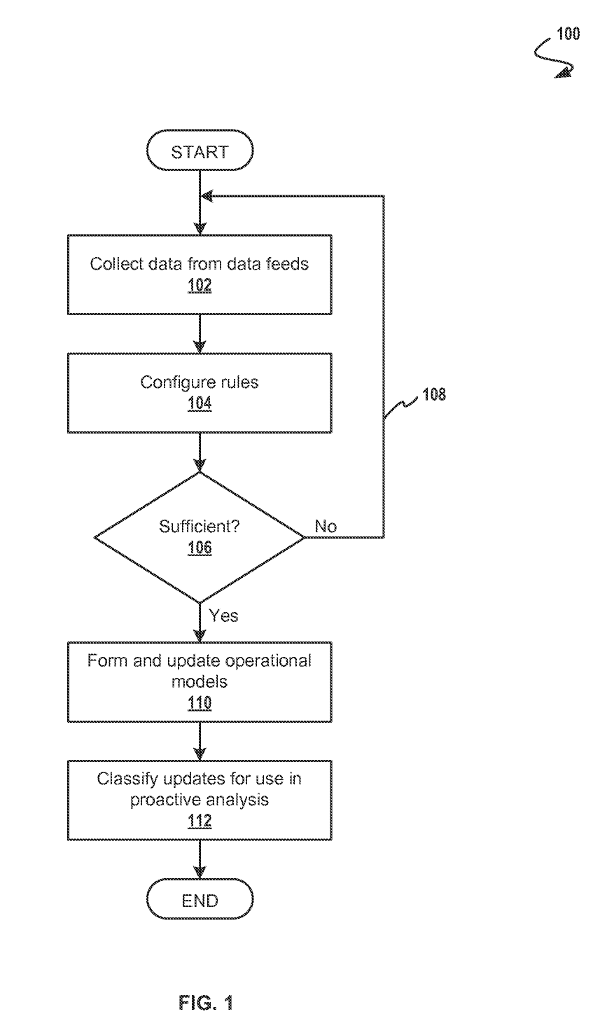

FIG. 1 is a flow chart showing steps for creating and updating an operational model. As shown, an operation (see operation 102) collects data from data feeds (e.g. HL7, DICOM) and configures rules (see operation 104). If the data collected is sufficient to configure rules, and the data collected is determined to be statistically sufficient (see decision 106), then operations to form and update an operational model are performed (see step 110). An update to an operation model can include additional previously-seen events, or an update to an operation model can be a new event that might be classified for use in proactive analysis (see operation 112). Thus, the practice of health care workflow can include use of a dynamically-updated model, and characteristics of such a model can be used for proactive identification of possible problems. For example, a dynamically-updated model can serve to identify resources that are inter-dependent (e.g. even in a complex system), and/or to anticipate failures (see the discussions of service level agreements, below), and also to serve to recommend compensating activities. In some embodiments, some of all of the above operations and decisions are made in a system comprising operational modules and databases configured to aid in the practice of health care workflow modeling using proactive metrics. The flow of data and performance of operations as outlined in FIG. 1 are further described below

### Data Collection Phase

The first phase of integrating an analytics package into a workflow system is to define a preliminary set of metrics and establish a baseline set of metric values based on current operations against which to compare and improve. This is the data collection phase. The requisite data feeds are configured—such as HL7 and DICOM—and data is collected and rules configured to present current statistics on operational performance.

The data collection phase allows a baseline model of the operational performance of users, departments and institutions and acts as the primary input to creating an operational model to improve workflow efficiency.

### Productivity Modeling Phase

Once sufficient operational data has been collected, a baseline model can be created. Subsequently, a comparison of real-time performance characteristics against the retrospective model can determine bottlenecks or other inefficiencies in the current performance of users, departments, or the institution overall. The result of this productivity modeling phase could be as simple as determining the practical user or departmental load limitations to prevent over-committing of resources, to a set of dynamic rules that in real-time can evaluate operational performance and reassign work to improve throughput and reduce service delivery times.

One difference between most analytics systems and the solutions disclosed herein is that most systems display values of static metrics that are preconfigured with no a priori rationale behind what the anticipated improvements should be. By being tightly coupled to the workflow system, the practice of health care workflow modeling with metrics provides a mechanism to model the workflow at an institution so that a set of rules can be configured to dynamically address inefficiencies in the existing workflows discovered during the modeling phase. In addition, the operational models derived from the practice of health care workflow modeling with proactive metrics can evolve as more complex operational relationships are discovered or existing workflows change.

### Reactive Analytics

Metrics that address retrospective conditions, i.e., policies that are violated such as a report was not completed within the expected time, are reactive. That it, these metrics report violations of expected operational behavior. One objective of an advanced workflow practice is to avoid any operational policy from being violated by monitoring the actual performance against the expected performance and adjusting the workflow to compensate.

### Proactive Analytics

Proactive analytics are much more complex than reactive analytics as they require an underlying model of the system being evaluated. For example, where a reactive metric can easily be put in place to alert the fact that a task, such as reading an unread exam, was not completed in the time expected; a proactive system would monitor the status of the task, the operational load on the assigned resource, the expected performance of the assigned resource and either alert an administrator to a possible conflict, or reassign the task to an available resource that could complete the task in the allotted time. By modeling the workflow, a policy failure can be anticipated and avoided.

This is not a new paradigm—simple versions are used in many industries. Examples are primarily in hardware systems where component performance can be modeled and monitored so that a user can be warned of an impending failure, such as a battery power monitor, or car oil monitor. The innovation in the practice of health care workflow modeling with proactive metrics is modeling of many resources that are inter-dependent in a complex system and anticipating failures and compensating in real time. The complex aspect of this type of system is the construction of the underlying health model. This is only possible with detailed, empirical knowledge of the performance characteristics of the components and overall system to be modeled. In the case of the analytics disclosed herein, such empirical knowledge can be collected in the data collection and productivity modeling phases.

One desired outcome of such detailed productivity modeling is to coordinate activity between and among multiple individuals and systems to improve efficiency. Another desired outcome of this approach is to take advantage of productivity metrics, and make results available to the users of the system in some meaningful, real-time fashion. By implementing a workflow solution to achieve the desired outcomes, users—such as radiologists, technicians and administrators—can easily see where bottlenecks may be appearing in their user, department or institutional workflows.

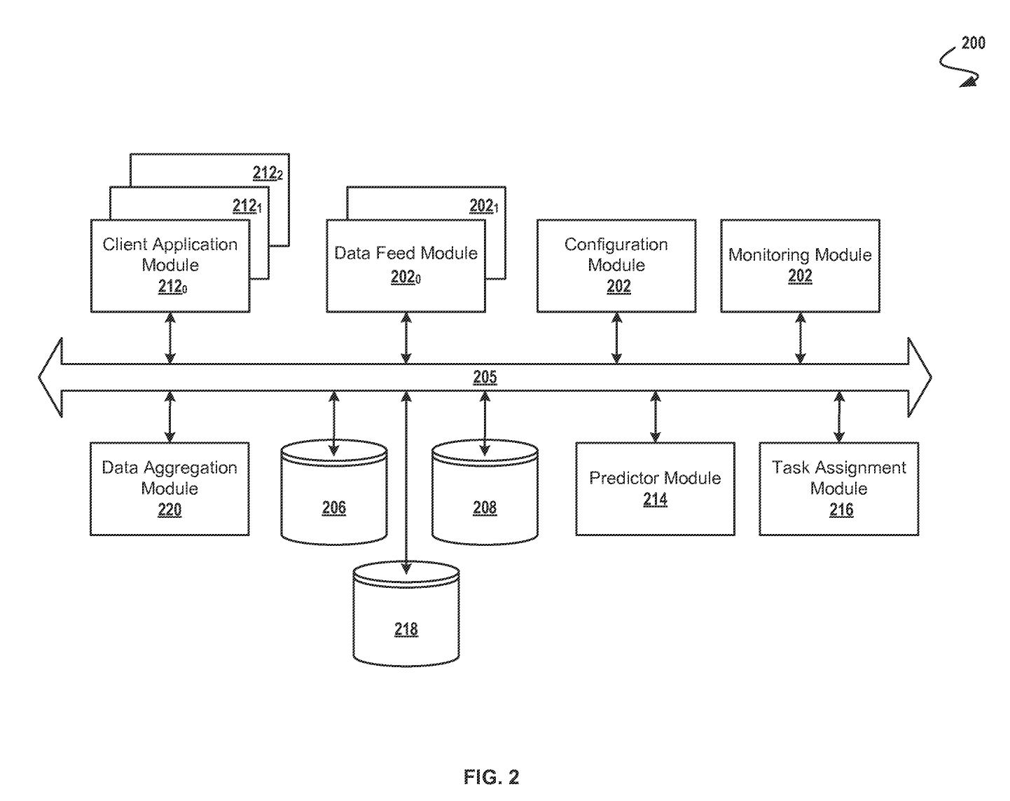

FIG. 2 depicts a system configured to aid in the practice of health care workflow modeling using proactive metrics. As shown, the system 200 includes modules and databases interconnected over communication bus 205. More specifically, modules configure to handle data feeds (e.g. data feed module 202₀, data feed module 202₁) are in communication with a configuration module 204. Some of the operations performed within the modules result in data, models, rules, etcetera stored in operations data archive 206 and/or real-time database 208, and or in long-term database 218.

### The Operations Data Archive

One component of the analytics solutions disclosed herein is the database of real-time and retrospective information. Historical operational data (e.g. operations data archive 206) is used to develop, maintain and evolve a dynamic workflow model, and real-time data is used to evaluate the current status against modeled objectives.

### Real-Time Database

The real-time database 208 maintains status and event information over a time window. This information is then incorporated into the long-term database (see below) at regular intervals. Dynamic tables and rule execution is performed against real-time database 208. For example, the list of all in-flight exam workflows that is maintained in a workflow server could be periodically evaluated for exams that are falling behind in their expected completion times. Another example may be to evaluate the exam load on an individual, or department resource to determine if reassignment of some exams should occur in order to avoid time-wise over-allocation.

### Long-Term Database

The long-term database 218 is the historical record of stored operational information. This long-term database 218 at is analyzed to construct operational models to improve efficiency.

### Monitoring Analytics

Once real-time and long-term operational databases are at least partially in-place, metrics can be evaluated and presented to individual, departmental or institutional users (see monitoring module 210). Depending on the maturity of the operational modeling, the system can support reactive and proactive metrics. The initial configuration of the analytics solution present reactive metrics, and present proactive metrics when at least a rudimentary objective model of operational characteristics is available. Such an operational model is incrementally developed and iteratively refined as the underlying workflows are developed.

### User and Departmental Analytics

Analytics can be reported (see client application module 212₀, client application module 212₁, client application module 212₂, etc), and can be filtered by individual users, groups of users or any other persisted criteria. As the resource requirements of any specific task or tasks are understood from the empirical modeling phase, expected throughput can be modeled on a resource-by-resource basis. For example, by monitoring how many studies are read by an individual radiologist or a group of radiologists, a baseline average completion time can be obtained. At any point in time during the day, a user or group of users can be examined to determine if there is a reasonable expectation that their assigned workload will be completed. In some embodiments, a reactive metric—such as exams not completed on time—can be put in place. Further, in some embodiments, a proactive metrics (e.g. resource overloaded) or alerts (e.g. exams that will not be completed on time without attention) can be put in place.

### Using Analytics

One purpose of having an analytics solution is to improve patient care. This is attained by improving workflow efficiency, including optimization of resource utilization.

### Operational Modeling

Before quantitative optimization of a process can occur, the process must be quantitatively measured (e.g. observed, analyzed, modeled, etc). In the case of a healthcare institution, quantitative data must be collected on operational characteristics such as average time to complete exams of different types, or average time to complete exams by different radiologists, even average time to complete exams at different times of the day. By simultaneously collecting information on patient admissions or registration, exam status changes and other metrics, more complex models can be constructed to understand patient waiting times per procedure, efficient use of modalities, time-dependent resource efficiency (i.e., is there a lower productivity rate after lunch, or on weekends), etc.

As operational characteristics (statistics) are analyzed, an iterative model of the operational workflow at an institution can be built up. As the model evolves, reactive metrics can be replaced with proactive metrics by the design and implementation of rules that monitor the state of the overall system to predict possible problems or inefficiencies.

### Predictive Workflow

Another benefit of having an operational model against which to compare real-time operations is that a task arbitrage layer can be implemented (see predictor module 214). An example of this would be an automated exam assignment system that can adjust exam priority and reassign exams to alternate resources based on projected bottlenecks in user, departmental or institutional workflow (see task assignment module 216).

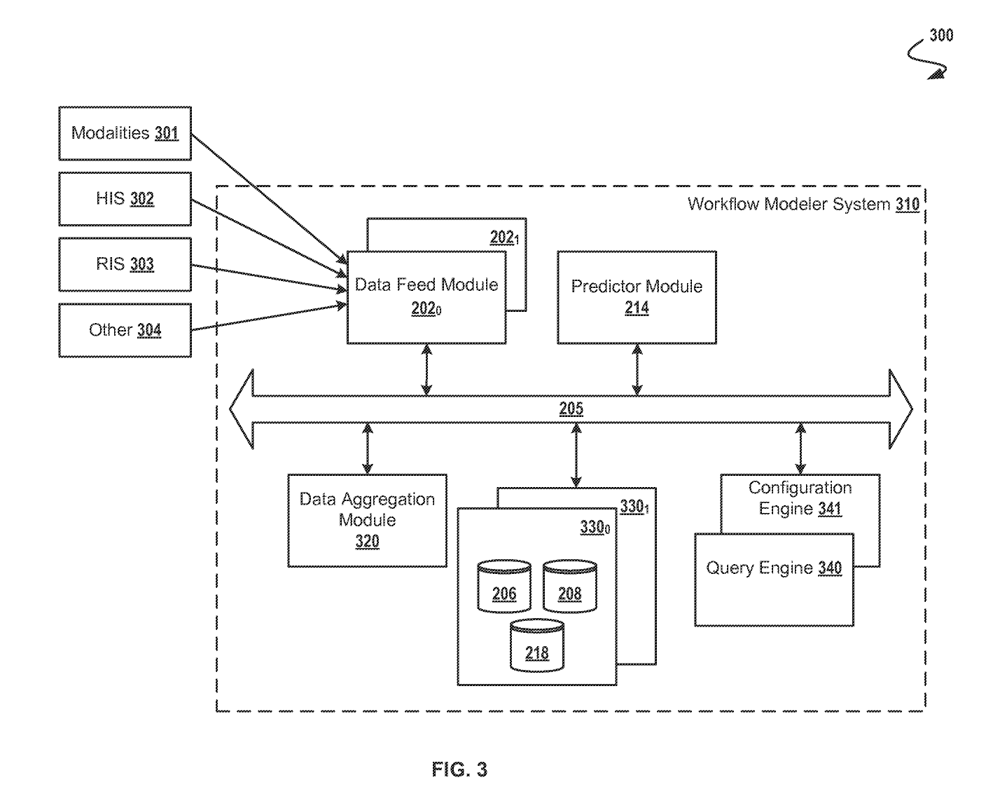

FIG. 3 depicts a system for health care workflow modeling with proactive metrics. As shown, the system 300 comprises certain modules as earlier-described. For example system 300 comprises a plurality of instances of a data feed module 202, and comprises a plurality of stores, such as the operations data archive 206, the real-time database 208, and the long-term database 218, which can in turn be configured into a data access module 330 (as shown). Some embodiments include two or more data access modules. For example, the operations data archive 206, the real-time database 208, and the long-term database might be accessed through the data access module 330₀, and a second data access module, namely data access module 330₁ might serve as a repository for worklists, workflows, rules, statistics, and other persistent data (as discussed below). A collection of modules, such as are shown in FIG. 3, can be configured for cooperative communication so as to implement a workflow modeler system 310. And, such a workflow modeler system 310 can interface with any forms of a client application module 212 to interact with a user. In exemplary embodiments, the client application module 212 comprises a graphical user interface to serve the purposes of input/output with a human. However, a client application module 212 may comprise a machine interface (e.g. an application programming interface) to serve the purposes of input/output with a computer.

As shown, data feeds from various sources in the healthcare enterprise are processed by a data feed module 202 and/or a data aggregator 220. The data feeds can include modalities 301 (e.g. CR, MR, CT, etc.), a hospital information system 302 (HIS), the radiology information system 303 (RIS) and other systems 304 which can include scheduling systems, or any other source of clinical, diagnostic, operational, or financial information. The data aggregator 220 is responsible for parsing the data feeds in whatever format is presented, performing any needed translations or mappings, filtering the data pertinent to workflow support and filing into a data access module 330 within the workflow modeler system 310.

The data access module 330 within the workflow modeler system 310 is comprised of one or more logical databases embodying data models used to represent and persist the data presented by the data aggregator 220.

As shown, the configuration engine 341 of the workflow modeler system is responsible for storing specification of all healthcare enterprise resources that are to be modeled, the data fields needed to compute the operational characteristics of the resource, and any mapping or computational models needed to extract the desired result from the persisted data. Depending on the configuration, the results can be cached on a resource-by-resource basis. The query engine 340 exposes a set of interfaces to respond to queries about information stored in the data access module 330, or to evaluate workflow models.

The data stored in the data access module 330 of the workflow modeling system may include, but is not limited to:
information about upcoming or future scheduled procedures, such as time, location, an indication of the personnel performing the procedures, a procedure protocol, the patient, the reason for procedure, etc.;
information about procedures that are in-process, such as current status, indications of status changes, status change times, an indication of the personnel performing the procedure, patient, etc.;
information about prior-performed procedures;
patient logistics information such as admissions, discharges, or transfers;
information about current and prior clinical and diagnostic reports, including any resultant diagnostic nomenclature or codes such as CPT (Current Procedural Terminology), IDC9 (International Classification of Diseases), IDC10, HCPCS (Healthcare Common Procedure Coding System);
performing resource identification and classification (e.g. physician, specialist, radiologist, administrator, technician, etc.), plus schedule and contact information; and
information about inanimate resources used in workflow scenarios such as modalities (MR, CT, CR, etc.), and/or information about clinical or diagnostic facilities, etc.

This information resides in numerous systems within a healthcare environment, and in many cases is not available in the needed form or formats. Various embodiments are herein disclosed such that the embodiment functions using the available information in order to build a corresponding operational model. Additional or augmented data sources can be added at any time to improve the completeness and accuracy of the operational models. In exemplary embodiments, the data collection process is a continuous process, and the underlying models are continuously updated with new information.

Once the available data sources and fields are identified, individual resources can be configured. This configuration step is optional, as in many cases any needed information can be directly queried from the data access module 330 and processed through the query engine 340. Configuration of specific resources can allow real-time access to models of operational behavior. Performance of access can be facilitated by caching results, or by building up and storing incremental results.

Some examples of data to be consumed, normalized and persisted through the data aggregator 220 comprise:
Scheduled Exams
   Date/time normalized to UTC (universal time code) plus offset
   Location (facility, department, room, etc.)
   Type of exam, identified by modality, procedure, protocol or other identifying code
   Scheduling physician
   Patient
   Referring physician
In-Flight Exams
   All scheduled exam information
   Date/time of status changes
      Performing resource, usually a physician
      New status (performed, read, finalized, etc.)
Finalized reports
   Result code(s)
In-patient roster
Admitted out-patient roster
Human resources—physicians, technicians, administrators, etc. classification (e.g., general practitioner, radiologist, specialist, etc.) contact information and schedules
Other resources—modalities and schedules, etc.
   Also, a number of resources can be modeled as to its operational characteristics, such resources comprising:
Reports
   Average time to produce a report
      Discriminated by presence of pathology or specific result code
      Discriminated by a specific physician
      Discriminated by a time of day
      Discriminated by a particular location
Individual Physician
   Average time to produce a final report
Type of Physician
   Radiologist
   Specialist
Modality Technician
   Average time to capture an exam
      Discriminated by modality
      Discriminated by protocol
Patient
   In-patient waiting time for results
   Out-patient waiting time to be seen
   Out-patient waiting time for results
Modalities
   Average time per procedure
      Discriminated by protocol
   Average utilization (idle time)

Any of these characteristics can be discriminated down to the granularity of the available information, such as specific modality, protocol, performing resources, time of day, span of time, cost of specific resources etc. And such characteristics can be discriminated for the purpose of development and evaluation of complex models. For example, an individual resource or group of resources can be modeled and analyzed to determine their effectiveness over the course of any time period, such as in the morning, versus after lunch, versus late in the afternoon, etc. Another example is that the benefit of adding less-expensive resources such as lab technicians or assistants to improve the efficiency of over-loaded high-priced resources such as radiologists can readily be evaluated.

This ability to retrospectively model any resource or set of resources is used advantageously in the design and implementation of effective workflow. Many healthcare institutions have put workflows and procedures in place based on intuition or experience but have no qualitative or quantitative way of evaluating the efficiency of the processes involved in the workflows and procedures. By collecting real-time operational information and storing this for retrospective analysis, one can model new workflows as well as compare the new workflows against other workflows to determine how to optimize efficiency.

The workflow modeler system 310 supports the configuration of resources, types of resources, and/or groups of resources to be actively modeled. These models can manifest as queries to the data access module 330, or can be stored procedures to process new in-coming data into a more complex model than is supported natively by the data access module 330. An example of such a stored procedure model would be to compute the average, median and standard deviation of the time to perform a particular procedure such as finalizing a report. Depending on the richness of the available information, this could be further refined to modeling the time to complete a report when there is a positive result, as opposed to a negative result; or modeling a particular reading physician, or type of physician. The results of these configured stored procedures can either be stored in a separate logical database, or included in data access module 330.

Workflows to be evaluated can be modeled as graphs of processes that interact in a particular order, and with a particular set of constraints. These processes can be modeled as requiring one or more resources. The workflow can then be evaluated against the retrospective operational database to determine a qualitative, or quantitative efficiency relative to the empirical observations. This mechanism allows a meaningful comparison of any two workflows that will yield a relative efficiency and thereby allow the optimization of workflow based on empirical observations.

The client application module 212 consists of user interfaces to configure and administer the components of the workflow modeler system 310, user interfaces to configure resources and stored procedures, and user interfaces to configure and evaluate workflows.

Some examples of specific uses are described in the following paragraphs.

### Altering an SLA (Service Level Agreement)

In many healthcare environments, there are varying degrees of priority that are assigned to activities within studies. For example, an emergency room patient study has a high priority due to the time criticality of the care required. Another example would be an in-patient routine study such as an x-ray to evaluate recovery progress would have a relative low priority.

All of these studies are usually read by the same pool of physicians. In many institutions, these studies go into a global “pool” of exams to be read, but some institutions assign priorities to the studies so that they can be read in a particular order.

In this example, assume it is proposed to alter the maximum time to complete an emergency room study from 2 hours to 1 hour. By using the techniques of the disclosure herein, the retrospective analysis of the expected number of exams of different types and priorities and the requisite resource utilization can be analyzed to determine if this new requirement would cause an undesired perturbation or failure in other interacting workflows. In addition, in some cases, the specific failure mechanism could be identified and corrective action prescribed. For example, if the proposed change causes a failure in a related workflow due to the statistical overloading of a particular type of physician, an additional physician can be allocated based on the criticality of the change.

This entire analysis can be done without altering any in-place workflow, and corrective action prescriptions to achieve the desired result can be known to be feasible and can immediately be implemented.

### Evaluate the Loading of a Resource

Often, in complex workflows, several resources are utilized. For example, in one variation of a workflow to produce an x-ray study for a patient that has come in to an emergency room, the resources might include: the admissions staff, the triage nurse (e.g. to determine the priority of the patient), the physician (e.g. to evaluate the condition of the patient and determine the course of care), the orderly (e.g. to take the patient to the x-ray facility), the technician (e.g. to perform the procedure), the modality (e.g. to capture the x-ray), and the radiologist (e.g. to read the x-ray).

Each of these resources perform tasks that require a non-zero amount of time, so the resource might be subjected to scheduling against other tasks. By using the techniques disclosed herein, any of the performing resources can be evaluated against retrospective performance to determine if a particular proposed resource allocation achieved better performance (e.g. throughput, utilization) as compared to historical norms. For example, if one or more resources were under-utilized due to the bottleneck effect of having one or more specific fully- or over-utilized resources, then (for example) the overall efficiency of the workflow might be improved by assigning an additional resource of the specific type of resource in order to enable full utilization of all resources used by the workflow.

Again, this analysis can be done without altering any in-place workflow, and the result will be known to improve efficiency and patient care.

### Financial Analysis

Determining cost profiles in healthcare institutions is a complicated task. With so many different resources interacting in complex ways, assigning cost to specific areas sometimes results in quite inaccurate results. By incorporating resource cost information and using the retrospective analysis to determine utilization of specific resources in workflow scenarios, much more accurate cost analysis is possible. Beyond the ability to audit cost of specific procedures, the techniques disclosed herein allows for the analysis of the financial impact of workflow variations.

A specific class of examples would be the evaluation of cost implications of adding additional resources of one type to improve the efficiency of the use of other, potentially more expensive resources. For example, if a reading radiologist is only busy half the time, then a question to answer is, “is the cost to add an additional modality and requisite support infrastructure to get full utilization of the radiologist a justified cost?” Another example would be whether the cost of a new CT scanner and related support resources is justified by the additional prospective reimbursement of the procedures performed.

Again, this analysis can be done without altering any in-place workflow or adding new equipment, and the financial implications can be quantitatively understood before making the changes.

### Embodiments of Analytics Solutions

### Analytics Overview

Health care workflow modeling with proactive metrics can be practiced using a set of components integrated into a cohesive system. As discussed above, systems such as system 200 are configured to consume data feeds from multiple sources, and to collect operational statistics to enable analysis of an institution's existing workflow. Additional operations in systems such as system 200 facilitate the creation of new sets of metrics and rules, which in turn are used to optimize resource utilization. Various analytics solutions discussed herein supports the calculation of reactive metrics, such as operational SLA's, and issuance of alerts such as a notification if an emergency department report has not been completed within a specified length of time since the procedure. Other proactive metrics can be calculated, and issuance of alerts can include warnings. For example, a warning can be issued indicating that one or more resources are over-subscribed (e.g., due to a radiologist's reading load and average rate of completion, thereby leaving exams left unread). As an institution's operational characteristics are more completely and more accurately modeled by results of monitoring empirical results (and forming models), ever more sophisticated rules and metrics can be developed, and used to optimize workflow. In exemplary embodiments, analytics solution results can be used directly (e.g. by a computer) to optimize workflow.

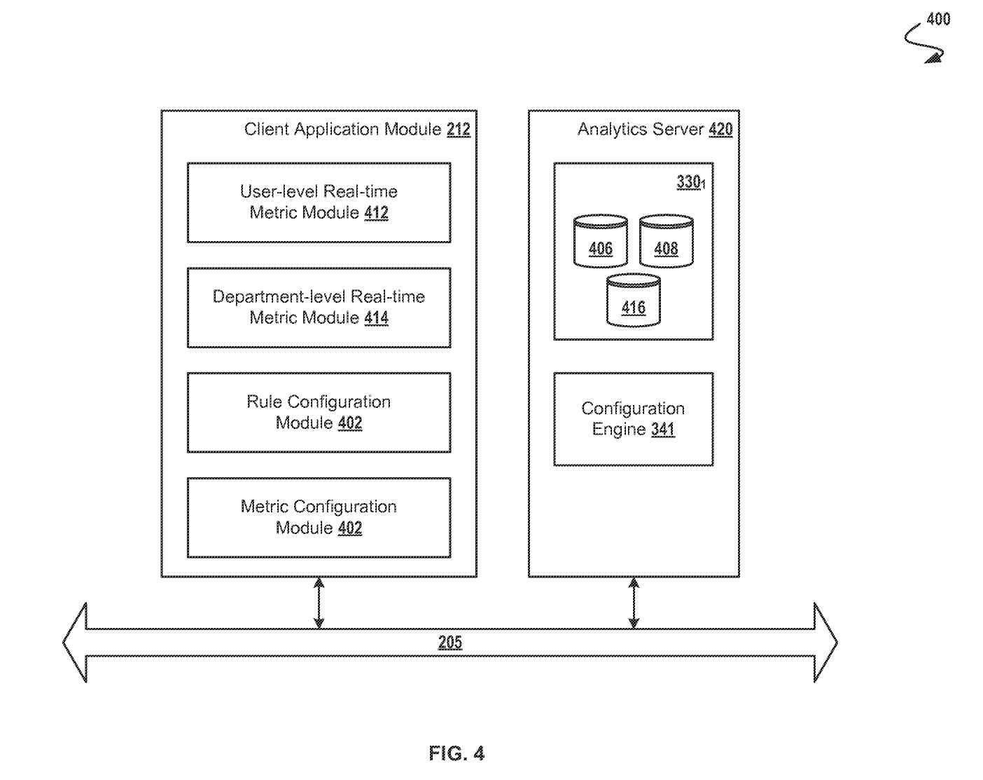

FIG. 4 depicts a system in which analytics solutions can be practiced. As shown, the system 400 comprises a client application module 212 and an analytics server 420. The client application module 212 and an analytics server 420 are in cooperative communication over communication bus 205. The modules, their intercommunication, and constituent components are further discussed below.

### Client Components

The client application module 212 of an exemplary analytics solution comprises a dashboard to display configured metrics (see below), a query interface to interrogate the operational archive, and a configuration interface to define, order and persist metrics and rules.

As shown, the client application module 212 comprises several client sub-applications:
A User-level Real-Time Metric Module 412
A Departmental-level Real-Time Metric Module 414
A Rule Configuration Module 416
A Metric Configuration Module 418

These sub-applications allow intercases as follows:
an individual user to select and display defined metrics (see User-level Real-Time Metric Module 412),
an administrator or department manager to select and display defined metrics for one or more users or groups (see Departmental-level Real-Time Metric Module 414),
an administrative interface for defining new rules and for configuring privileges for users or groups to use them see Rule Configuration Module 416) and
an administrative interface for defining new metrics, and for configuring privileges for users or groups to use them (see Metric Configuration Module 418).

### Analytics Service: Server Components

The analytics server 420 of an exemplary analytics solution comprises modules to perform analysis, and to communicate with the aforementioned client components. Such client components (e.g. constituents of client application module 212) can communicate with a server-side analytics service (e.g. within analytics server 420) that aggregates information to for display. The server components of the analytics solution can include or otherwise communicate with one or more data access modules 330, which contains repositories of information about in-flight workflows, operational data, configured metrics and configured rules. In some embodiments, a first data access module 330₀ is configured to comprise data archive 206 and/or real-time database 208, and or in long-term database 218. In some embodiments, a second data access module 330₁ is configured to comprise an operational archive, as discussed below.

### Operational Archive

In addition to the databases heretofore discussed exemplary embodiments include additional repositories (e.g. databases) known as the operational archive. The following discussions include:
main clinical data repository 406
in-flight and recent workflow repository 408
operational data repository 418

The main clinical data repository 406 persists the clinical and diagnostic information pertaining to studies that are known to the system. Included therein are libraries of adapters to capture data from external sources, libraries of data models to normalize and store the data for consistent usage and, in some embodiments a separate filing engine to persist the data in the model.

The in-flight and recent workflow repository 408 persists all clinical and diagnostic information pertaining to workflows (studies) that are in-flight—i.e., from scheduled status through finalized status—along with a time window of finalized exams for analysis and review. In addition, the data access module 330 persists all operational data about the progress of the workflow that is available (e.g., status change times, exam access, open and close times, etc). In addition, as available, this in-flight and recent workflow repository 408 also persists information about patient scheduling such as arrival time, wait time, protocol procedure time, etc. This information allows for workflow analysis of the entire patient episode, as contrasted with just a portion of the episode (e.g. just the radiology-centric analysis). Much of the efficiency that can be gained in the healthcare environment is in efficient patient and protocol management, not just in optimizing the report turnaround time.

The operational archive persists the historic record of operational data. As the data ages off the logical in-flight and recent workflow repository, the clinical and diagnostic components are persisted in the main clinical data repository, and the operational data is persisted in the operational archive. Though the one function of the operational archive is to provide a view of gross operational characteristics, an “Honest Broker” mechanism is maintained to allow regression against the main clinical data repository for analysis of specific patient or study episodes. An “Honest Broker” mechanism can be implemented as a secondary database that allows the correlation of anonymized data to the actual instance.

### Configuration

As shown, the analytics server 420 comprises a configuration engine 341, which engine can perform operations to configure rules, metrics and queries for use in the client applications.

Configuration of systems for the practice of health care workflow modeling with proactive metrics sometimes requires an audit of available data sources to determine what metrics and rule profiles can be supported, and a configuration engine 341 serves such purposes.

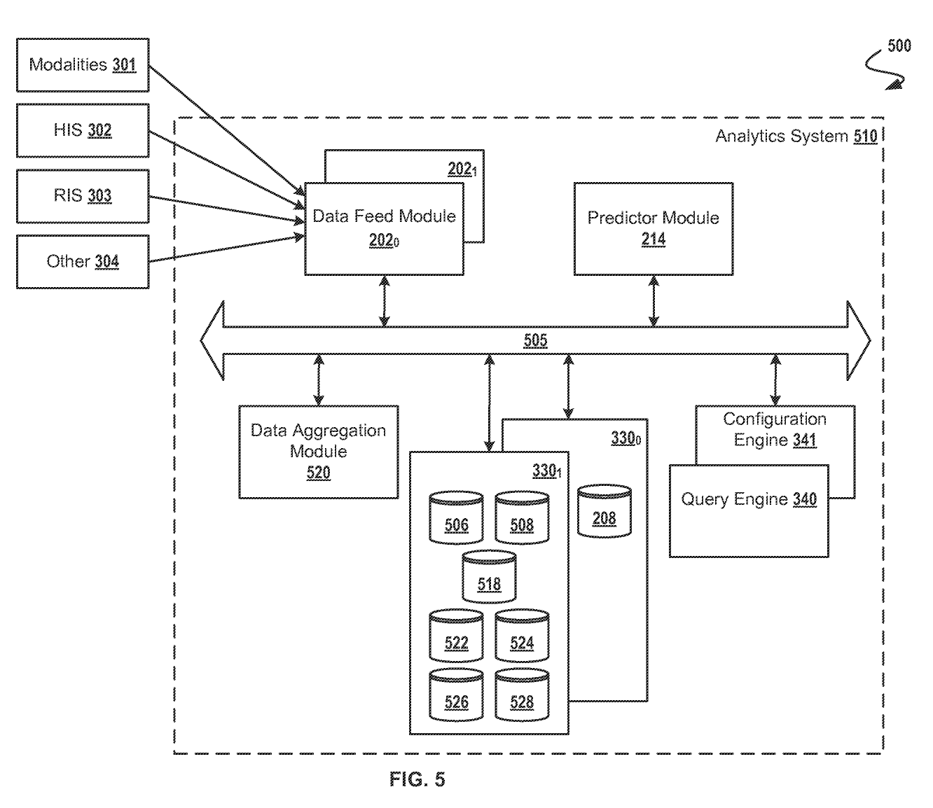

FIG. 5 depicts a system for health care workflow modeling using an analytics server. As shown, the system 500 comprises certain modules as earlier-described. For example system 500 comprises a plurality of data feed modules 202. A collection of modules such as are shown in FIG. 5 can be configured to be cooperative communication so as to implement an analytics server 420. And, such an analytics server 420 can interface with any forms of a client application module 212 to interact with a user. In exemplary embodiments, the client application module 212 comprises a graphical user interface to serve the purposes of input/output with a human. However, a client application module 212 can comprises a machine interface (e.g. an application programming interface) to serve the purposes of input/output with a computer. The embodiment of analytics server 420 as shown in FIG. 5 shares some characteristics with the workflow modeler 310, however some of the significant differences are briefly discussed below.

### Data Sources

Different institutions distribute operational data in different forms. Strictly as examples, operational data can be stored and disseminated via HL7, DICOM tag values, HIS feeds, etc. Systems for the practice of health care workflow modeling with proactive metrics abstracts the data sources through the use of various components, and any one or more data feed modules 202 can be implemented to normalize data from multiple sources such that an analytics system 510 can operate without knowledge of the specific formats, and/or without knowledge of the exact data sources. As such, various embodiments can be configured to consume the various different data sources in order to acquire the operational information used to compute the metrics and/or execute the rules as part of the workflow integration.

### Operational Worklists

In addition to the data sources discussed above, there are two dynamic worklists discussed below:
Scheduled Exams Worklist 506: A worklist of all scheduled exams and their related meta information, such as status, in a configured time period, such as the next 24 hours, next 48 hours, etc.
In-Flight Studies Worklist 508: A worklist of all studies and their metadata fields. Status can be provided for any of the in-flight studies (e.g. studies that have been performed but not yet read and finalized).

These worklists can be displayed and/or can be filtered by any of the available metadata fields—modality, specific machine, location, time frame, body part, assigned radiologist, etc.

### Operational Statistics

FIG. 5 shows an instance of a baseline operational statistics dataset 518 that can be queried to assist in operational modeling. Some examples of constituent statistics are:
Exam Times: Status change time periods such as scheduled to performed, performed to read, read to finalized, etc. These queries can be further specified to discriminate individual modalities, machines, technicians, radiologists, etc.
Resource Efficiency: Exam status change per resource such as exams performed by technicians per day, exams read by radiologists per day, etc. These queries can be further specified to discriminate finer detail.

### Reactive Rules

Example baseline reactive rules 522 are:

| Metric/Rule | Description |
|---|---|
| Exam status | Exams can have associated service level agreements, such |
| change | as, an inpatient study must be read within 4 hours, or an |
| failed SLA | outpatient study must be read within 2 hours, etc. |
| | Violation of the SLA can be alerted. |
| Scheduled | Scheduled resources, such as technicians or radiologists |
| resource | that are not on-line can be alerted. |
| not available | |
| Performed | If an exam goes from scheduled to performed, but no |
| study has | images are registered, alert the system. |
| no images | |
| Read study | If an exam goes from performed to read, but no report |
| has no | is registered, alert the system. |
| report | |

### Proactive Rules

Once a baseline operational model is developed, proactive rules 524 can be implemented to alert the system about impending problems. Returning to the discussion of FIG. 1, as data is collected from data feeds, and as rules are configured and applied, operation 110 serves to form and update operational models. As successively more data is collected from data feeds, and as operation 110 iteratively serves to form and update operational models the model become useful for detecting anomalies. For example, if a particular radiologist has a historical average of “3 studies per hour”, but a recent data collection indicated that particular radiologist has a recently-sampled average of only “1 studies per hour”, the workflow modeler system can detect that as an anomaly vis-à-vis the rules, and issue an alert. The foregoing is merely one example. In addition to issuing an alert, as the models within the workflow modeler system 310 evolve, many of these proactive rules can synthesize workflows intended to correct the detected anomalies. Table 1 gives a selection of possibilities where a rule is applied, giving a result, which result can be used in synthesizing a corrective workflow.

TABLE 1

| Metric/Rule | Description |
|---|---|
| Resource | A technician, radiologist, modality has too many studies |
| is over- | assigned to them to complete in the expected time frame. |
| subscribed | |
| Performed | An in-flight workflow is likely to fail an SLA based on |
| exam likely | projected resource efficiency and utilization. E.g., a |
| to fail SLA | radiologist has 10 studies left to read in the next 3 |
| | hours, but their average rate is 3 studies per hour. |
| Resource | A technician, radiologist, modality is not fully utilized |
| is under- | with the current projected workload. Additional |
| subscribed | procedures could be scheduled. |
| Repository | Access times to data repositories can be monitored for any |
| fetch times | deviation from the expected rates. Can indicate impending |
| are | network or system problems. |
| degrading | |

### Metrics—Data Source Dependencies

The capabilities of a workflow-integrated analytics solution can be dependent on what data sources are available, and how mature the operational models of the institution is. Many valuable baseline metrics can be collected by monitoring the basic worklist and reporting system utilization, and still higher valued metrics are the ones that trigger rules to allow the system to predict problems, rather than merely report problems.

### Use Cases

As discussed above, most healthcare institutions have sets of processes and procedures in-place that govern how work is to be performed—and following the descriptions above, this is known as the workflow. The following use cases suggest and analyze particular deployments of the herein described systems for health care workflow.

The paragraphs below cover a range of use cases including:
Workflow Modeler System: Prototyping
Workflow Modeler System: Proactive Modeling
Analytics System Use Cases

### Workflow Modeler System: Prototyping

The disclosures above describe systems that can be configured to consume any available data feed from information sources within a healthcare institution, parse and normalize (convert the data to a common format that is understood by the system) the data pertinent to workflow and file the data, or a reference to the data location, in one or more databases. The system can further be configured to perform analysis based on real-time and/or retrospective information to characterize the current, or historical behavior or performance of any resource or set of resources in the healthcare institution.

One application of such a prototyping capability is to enable prototyping of workflow variations within the healthcare institution with the ability to qualitatively and quantitatively evaluate the relative efficiencies of these workflow variations. Such a system enables the design of optimized workflow by using retrospective and real-time modeling of all component resources to characterize the overall efficiency of one or more processes or procedures relative to the empirically determined performance of the component resources. In this context, a “resource” is any participant in the workflow—a physician, a technician, a modality, a patient, a waiting room, etc.

In exemplary embodiments, the query engine 340 of the workflow modeler system 310 is responsible for storing specification of all healthcare enterprise resources that are to be modeled, the data fields used to compute the operational characteristics of the resource, and any mapping or computational models used to extract the desired result from the persisted data. The query engine 340 exposes a set of interfaces to respond to queries about information stored in the data access module 330, or to evaluate workflow models.

The data stored in the workflow modeler system 310 may include, but is not limited to:
1. information about scheduled procedures, such as time, location, performing resource, protocol, patient, reason for procedure, etc.
2. information about procedures in-process, such as status, status changes, status change times, performing resource, patient, etc.
3. information about prior procedures
4. patient logistics information such as admissions, discharges, or transfers
5. information about current and prior clinical and diagnostic reports, including any resultant diagnostic nomenclature or codes such as CPT (Current Procedural Terminology), IDC9 (International Classification of Diseases), IDC10, HCPCS (Healthcare Common Procedure Coding System)
6. performing resource identification, classification (physician, specialist, radiologist, administrator, technician, etc., schedule and contact information
7. information about inanimate resources used in workflow scenarios such as modalities (MR, CT, CR, etc.), clinical or diagnostic facilities, etc.

The above-listed information often resides in numerous and disjoint systems within the average healthcare environment. The embodiments disclosed herein can process with nearly any information that is available in order to build an accurate operational model (e.g. accurate to the accuracy of the input data). As discussed in FIG. 1, additional or augmented data sources can be added at any time and can further improve the accuracy of the operational models. Data collection is a continuous process, and the underlying models are continuously updated with new information.

Once the available data sources and fields are identified, individual resources can be configured. This configuration step is optional, as any needed information can be directly queried from the data access module 330 and processed through the query engine 340. Configuration of specific resources can allow real-time access of potentially complex models of operational behavior by caching results, or building up and storing incremental results.

Some examples of data to be consumed, normalized and persisted through the data aggregator 220 are listed below. However, a listed data field is not necessarily complete as described, and the actual data consumed can depend on the specific nature and granularity of the data from the data source:
1. Scheduled Exams
   a) Date/time normalized to UTC (universal time code) plus offset
   b) Location (facility, department, room, etc.)
   c) Type of exam, identified by modality, procedure, protocol or other identifying code
   d) Scheduling physician
   e) Patient
   f) Referring physician
2. In-Flight Exams
   a) All scheduled exam information
   b) Date/time of status changes
   c) Performing resource, usually a physician
   d) New status (performed, read, finalized, etc.)
3. Finalized reports
   a) Result code(s)
4. In-patient roster
5. Admitted out-patient roster
6. Human resources—physicians, technicians, administrators, etc. classification (e.g., general practitioner, radiologist, specialist, etc.) contact information and schedules
7. Other resources—modalities and schedules, etc.

Further, outputs, specific resources (e.g. based on types and modalities) and other participants in a workflow can be operationally characterized. Examples of such include:
Reports
   Average time to produce a report
      Discriminated by presence of pathology or specific result code
      Discriminated by a specific physician
      Discriminated by a time of day
      Discriminated by a particular location
Individual Physician
   Average time to produce a final report
Type of Physician
   Radiologist
   Specialist
Modality Technician
   Average time to capture an exam
      Discriminated by modality
      Discriminated by protocol
Patient
   In-patient waiting time for results
   Out-patient waiting time to be seen
   Out-patient waiting time for results
Modalities
   Average time per procedure
      Discriminated by protocol
   Average utilization (idle time)

Any of these characteristics can be discriminated down to the granularity of the available information, such as specific modality, protocol, performing resources, time of day, span of time, cost of specific resources etc. for development and evaluation of complex models. For example, an individual resource or group of resources can be modeled to determine their effectiveness over the course of any time period, such as in the morning, versus after lunch, versus late in the afternoon. Another example is that the benefit of adding less-expensive resources such as lab technicians or assistants to improve the efficiency of over-loaded high-priced resources such as radiologists can readily be evaluated.

### Workflow Modeler System: Proactive Modeling

Once a prospective workflow model is selected for a particular scenario, the expected performance of each of the contributing resources can be derived by comparing prospective workflow analysis results to the retrospective analysis results. This provides a baseline performance expectation of the scenario. A healthcare institution can have any number of independent or inter-related workflows operating in parallel. Each of these workflows can be modeled, characterized and compared to retrospective analysis results.

In some embodiments, there are several logical databases in the workflow solution, as earlier introduced (see FIG. 5) and are further discussed below:
Main Clinical Repository: All patient and study information at the [multi-] institution, including reports. This is the permanent persistence database. This database should contain URI's to the referenced studies and reports, or sufficient information to access the referenced data.
In-Flight Repository: All information about exams that are not finalized, plus finalized exams in a configurable period of time, for example, all exams finalized in the last 30 days. This view of the data includes current exam status, all status change times, assigned resources, flags for workflow management, and any available information about the overall patient episode.
Operational Repository: All operational data for finalized exams. This data should be independent of the Main Clinical Repository, but the system should have an “honest broker” mechanism to correlate specific entries to the relevant exam to enable analysis of anomalous workflows. It should be noted that the primary purpose of the Operational Repository is to record gross characteristics of the performing resources and types of workflows—not any specific event, but rather composites of events. Nonetheless, the ability to regress against any specific entry is extremely valuable to analyze anomalous or otherwise interesting workflow results.

In an exemplary use case, an implementation of the In-Flight Repository could be a materialized view of the main clinical repository which would include additional fields for the operational information collected. In the table below, “n/a” indicates the data is not persisted, “I” indicates “implicitly available of the information” (e.g. the data is available through a compound query of the persisted data), and “E” indicates “explicitly available” (e.g. the data is stored in a directly queryable format). “Implicit” for the Operational Repository indicates the data must be persisted, but not necessarily exposed to a standard query. Operational data to be collected can include the data given in Table 2:

TABLE 2

| | Main | Oper- | |
|---|---|---|---|
| | CDR | ations | |
| Scheduled | N/A | E | Scheduled time for the exam. |
| time | | | |
| Protocol | I | E | |
| Modality | I | E | |
| Dept, | I | E | |
| Institution | | | |
| Assigned | I, N/A | E | Physicians, technicians |
| resources | | | |
| Current | N/A | E | |
| status | | | |
| Status | N/A | E | Scheduled, in-progress, preliminary, |
| changes | | | finalized, amended, cancelled, etc. |
| and times | | | |
| Patient | N/A | E | ADT information, waiting times, |
| episode | | | protocol-specific such as waiting time |
| information | | | for contrast agents, etc. |
| Diagnosis | I | E | CPT, ICD9, ICD10, HCPCS codes. At a |
| information | | | minimum, pathology present or absent. |
| Study UID | I | I | Required for “honest broker” |
| | | | functionality. |

In some cases, Implicit information in the database implies that the data is embedded in canonical formats such as DICOM tags or the diagnostic report, but not necessarily explicitly stored in a database field. The explicit data referenced above can be migrated to the Operational Repository on a periodic basis, which period can be configurable.

### Workflow Service Use Cases

The Workflow Service is responsible for configuring, managing and providing results for worklist queries. This service is also responsible for configuring, managing and executing rules. Possible monitoring and migration activities are given in Table 3. Several related proactive use case scenarios are discussed below the table.

TABLE 3

| Monitoring Activity | Migration Activity |
|---|---|
| The Workflow Service | This can be implemented as a polling |
| will monitor the | mechanism, a scheduled mechanism, or a |
| In-Flight Repository | reactive mechanism from one or more |
| for compliance with | external events. |
| configured SLA's. | Event (s) are raised |
| | associated with violated SLA's. |
| The Workflow Service | This can be implemented as a polling |
| will monitor the | mechanism, a scheduled mechanism, or a |
| In-Flight Repository for | reactive mechanism. |
| proactive metric events. | Event (s) are raised |
| | associated with proactive metrics. |
| The Workflow Service | This process should include removing |
| will migrate data from the | extraneous operational data from the |
| In-Flight Repository to the | materialized view in the Main Clinical |
| Operational Repository on a | Data Repository. |
| [configurable] periodic basis. | An event must be raised |
| | indicating the update has occurred. |

### Proactive Workflow Use Cases

Given the deployment of a system or systems as described above, and given sufficient time passage such that the systems have collected retrospective operational characteristics of individual physicians in a department. These operational models will contain the statistically calculated expected time for each of the individual physicians to produce a diagnostic report for a study. As an example, the can monitor the active list of exams to be reported and their current assignments to the reading physicians. Then, by comparing the existing exam load against the retrospective performance of the individual physicians, the system can determine whether a report or set of reports is forecasted to be completed within the expected time frame. If there is a forecasted failure in the SLA, then one or more exams can be reassigned to other available resources to prevent the failure. This is different than systems in use today that wait for a failure, and then indicate a failure has occurred, or in many cases just wait for a complaint from the party waiting for the report that it was not produced.

### Overloaded Resource

In this scenario, the workflow modeled involves scheduled x-ray scans. The resources involved are the admissions staff, the patient, the technician that performs the scan and the radiologist pool that evaluates the scan and writes a report. In many healthcare enterprises there will be many x-ray scanners, and a variety of study types being processed by the system. For example, emergency room patients, in-patients and out-patients. Each of the study types will have an associated priority to enable the system to process more critical study types more quickly. In this example, assume that a technician is falling behind, perhaps because of a difficult protocol, or late returning from lunch, etc. The system in the disclosed invention can anticipate that the delay in performing the scan will cause a delay in reading the exam which may violate the designed time for a patient to wait for a result.

The cause of the failure can be pin-pointed to be the technician component of the workflow and this can be signaled to administrator or other monitor. An additional resource can be assigned to alleviate the situation and prevent and failure in workflow.

### SLA Failure

In this scenario, the workflow modeled involves the reading radiologist. Most healthcare institutions will have a pool of reading radiologists that share the load from all modalities. The studies are assigned to radiologists based on institutional guidelines. The system in the disclosed invention contains both the modeled performance of the entire pool of radiologists, and the modeled performance for each of the individual radiologists. In this example, assume that a radiologist has taken more than the expected time to complete his first 25% of exams for the day. This could be due to an anomalous sequence of complex exams, or an impromptu consultation that interrupted him, or any one of a number of reasons. The disclosed system can monitor the progress throughout the day to determine that given the current state of the radiologist's workload, it is statistically likely that he will not complete one or more studies in the time required. This situation can be signaled to an administrator or other monitor to allow work to be reassigned, or in more sophisticated implementations, the work could automatically be reassigned to prevent any workflow failure from happening.

The client application module 212 consists of user interfaces to configure and administer rules associated with SLA's and workflow performance that is to be monitored. These rules determine the workflows to be actively monitored, the events to be raised based on threshold performance deviation, and the action to be invoked if any of the monitored conditions arise. These actions can be anything from signaling an administrator or other monitor, to invoking an agent to automatically correct the anomaly. In addition, the client application module 212 includes configured agents and interfaces for individuals to monitor the current status of any in-progress workflows in the system. These agents can be used for an individual to track their progress through the day, or to track the workload on a department, or track the status of any monitored resource in any workflow within the system.

### Analytics System Use Cases

The Analytics Service is responsible for configuring, managing and providing results for metric queries. Some use cases for the interaction with the Operational Repository are given in Table 4

TABLE 4

| Monitoring Activity | Migration Activity |
|---|---|
| The Analytics Service | When a metric is configured that uses |
| will execute and cache | retrospective operational information |
| results from queries | (such as the expected performance of a |
| against the Operational | resource, expected/historical study |
| Repository. | completion times, etc.) since the result |
| | of the query will not change until the |
| | next update of the Operational |
| | Repository, the result can be cached. |
| The Analytics Service will | Results may no longer be valid when the |
| flush all cached | Operational Repository is updated. |
| Operational Repository | Must subscribe to the Operational |
| results when the Operational | Repository update event. |
| Repository is updated. | |

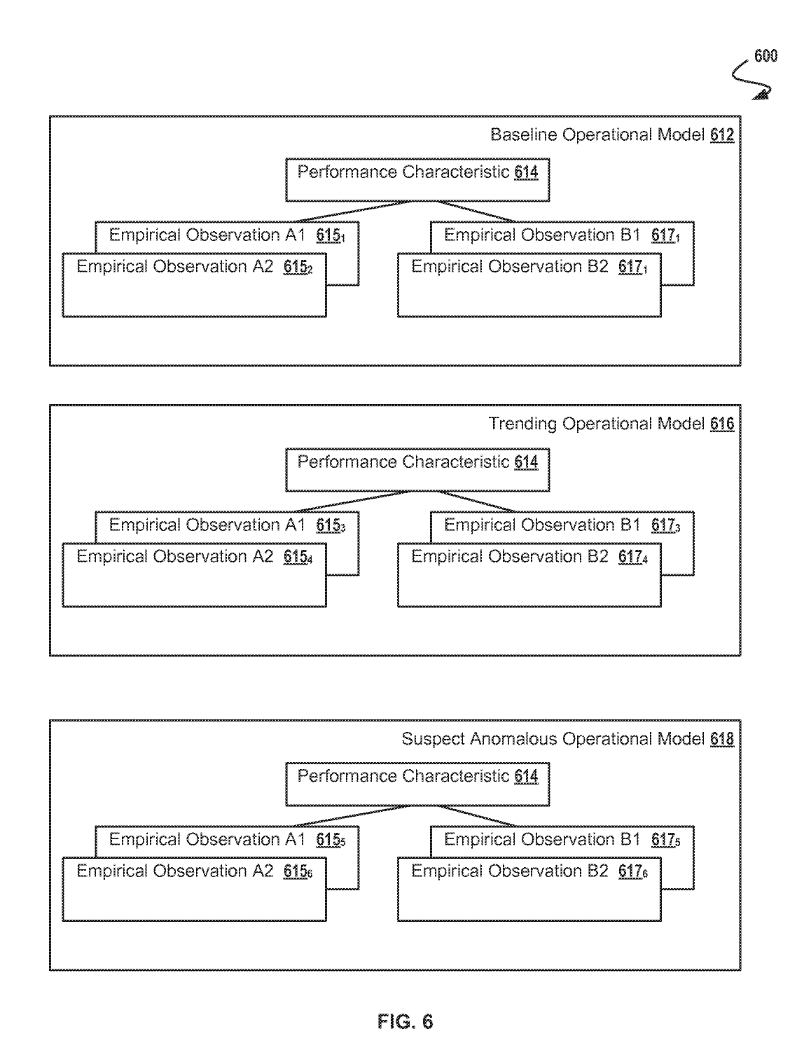

FIG. 6 is an illustration of a system 600 for analyzing health care workflows using an operational models. As shown, the system 600 comprises a baseline operational model 612, a trending operational model 616 and a suspect anomalous operational model 618. Each of the aforementioned operational models comprises a performance characteristic 614, and empirical observations. Strictly as an example, the baseline operational model can comprise a performance characteristic to measure the time delay in reading an exam. The empirical observations (e.g. empirical observation A1 615₁, or empirical observation A2 615₂) might measure the time delay in reading an exam for a particular radiologist. Further, system 600 comprises another model, the trending operational model 616, and the trending operational model 616 in turn comprises its own empirical observations (e.g. empirical observation A1 615₃, or empirical observation A2 615₄). Still further, system 600 comprises yet another model, the suspect anomalous operational model 618, and the suspect anomalous operational model 618 in turn comprises its own empirical observations (e.g. empirical observation A1 615₅, or empirical observation A2 615₆). Also shown are additional empirical observations, namely empirical observation B1 617, which empirical observation B1 is measured for a plurality of models.

Now, the performance characteristic can be virtually any characteristic that can be measured empirically. As described in the foregoing, a performance characteristic can be a temporal characteristic (e.g. time delay), however, a performance characteristic can be any sort of measurable quantity. For example, a performance characteristic can be the number of scans taken by a radiologist in advance of a particular procedure. Or, a performance characteristic can be any sort of qualitative aspect that can be codified as a quantity. For example, a performance characteristic can be the number of “patient's positive ratings” received by a radiologist.

Using an embodiment of system 600, a method for analyzing health information to optimize workflow can be practiced using one or more computers. In one embodiment, a user can configure a query where the query comprises a performance characteristic of some subject operational model (e.g. an operational model for measuring the latency of reading exams). That query can then be processed over a first operational model instance to form a baseline operational model. Such a baseline operational model can be (but is not necessarily) representative of a standard of care, or an SLA. For example, the baseline model might include empirical observations (or even coded-in observations) that indicate a mean-time for time delay from exam to reading of the exam by a radiologist.

Once at least one baseline operational model exists, then system 600 proceeds to process the query over a second operational model instance to form a trending operational model. The trending model, more specifically the empirical observations of the trending model can be used to compare against the baseline operational model in order to form one or more trends. For example, if the baseline model codified the mean-time for time delay from exam to reading of the exam by a radiologist as eight hours, and queries performed over one or more trending operational models returned consistently greater values (e.g. twelve hours, fifteen hours, etc) then the trend can be characterized as an increasing trend. And, using known techniques, the trend can be quantitatively characterized. Once a trend is quantitatively characterized, then a still further query over some operational model can be compared and analyzed against the trending model, and, if the comparison is outside of the quantitative bounds of the trending model, then an anomalous event can be detected, and the event can become the subject of a further analysis and possibly an alert. That is, the query can be processed over a third operational model instance to form a candidate anomalous operational model, and the candidate anomalous operational model can be compared to the trending model to identify a candidate anomaly.

Of course, any of the models in system 600 can be codified in a variety of ways, using a computer and data structures. For example, the performance characteristic to measure the time delay in reading an exam, and the empirical observations (e.g. empirical observation A1 615₁, or empirical observation A2 615₂) can be codified as a tree data structure, or a list data structure, or a graph representation, or a table or a relation in a relational database. Moreover, one or more empirical observations can be captured, and the capture might include additional information beyond the actual empirical measurement. For example, the measurement can be associated with a particular radiologist, or a particular department, or a particular type of equipment. Such associations can be used identify correlations related to the candidate anomaly.

Having such data structures for comparing then, it is possible to compare the aforementioned candidate anomaly against a plurality of operational models to identify one or more suspect specific causes of the candidate anomaly. For example, a long latency might correlate to a particular radiologist. Or, a long latency might correlate to a particular type of equipment. Or, it might be that a correlation to the radiologist is not statistically significant, and it might be that a correlation to a particular type of equipment is not statistically significant, yet there is a statistically significant correlation to the combination of the particular radiologist and the particular type of equipment. Thus, such associations can be used identify correlations related to the candidate anomaly, and the candidate anomaly can be used to identify one or more suspected specific causes of the candidate anomaly.

In an exemplary embodiment, the aforementioned techniques can be augmented by evaluating one or more workflow scenarios using at least one of, the baseline operational model, the trending operational model, and the suspect anomalous model. That is, the evaluation of one or more workflow scenarios can comprises generating graphs of processes that interact for a particular desired outcome, or within in a specified order (possibly with a set of constraints). In fact, a series of processes that interact in a specified order can be codified as a series of performance characteristics 614. In some cases processes that interact in a specified order can interact only at some discrete moments in time, and a significant portion of the processes can proceed in parallel. Often re-ordering steps, or concentrating performance improvements on one or more performance characteristics can significantly alter (e.g. improve) the outcome of the workflow. Accordingly, two workflows can be compared in order to yield a relative efficiency, and knowledge of relative efficiencies can be further used so as to converge to an optimized workflow. And, following this embodiment, the efficiency of the optimized workflow based on empirical observations, thus the optimized workflow has a high probability of success when implemented in the same environment in which the empirical observations were taken.

In addition to developing a new workflow model based as described above, it is reasonable and envisioned to develop a new workflow model based on altering a service level agreement (“SLA”). Such a new workflow model based on altering a service level agreement can be evaluated to determine if the altered SLA would cause a failure in other interacting processes or other interacting workflows.

Of course, the foregoing descriptions of the system 600 are purely exemplary, and many instances of incorporating additional information into the modeling, measurements and comparisons are reasonable and envisioned. For example, system 600 might incorporate information about scheduled procedures, such as time, location, performing resource, protocol, patient, reason for procedure, etc.; information about procedures in-process, such as status, status changes, status change times, performing resource, patient, etc.; information about prior procedures; various patient logistics information such as admissions, discharges, or transfers; and information about current and prior clinical and diagnostic reports, comprising any resultant diagnostic nomenclature or codes such as CPT (Current Procedural Terminology), IDC9 (International Classification of Diseases), IDC10, HCPCS (Healthcare Common Procedure Coding System).

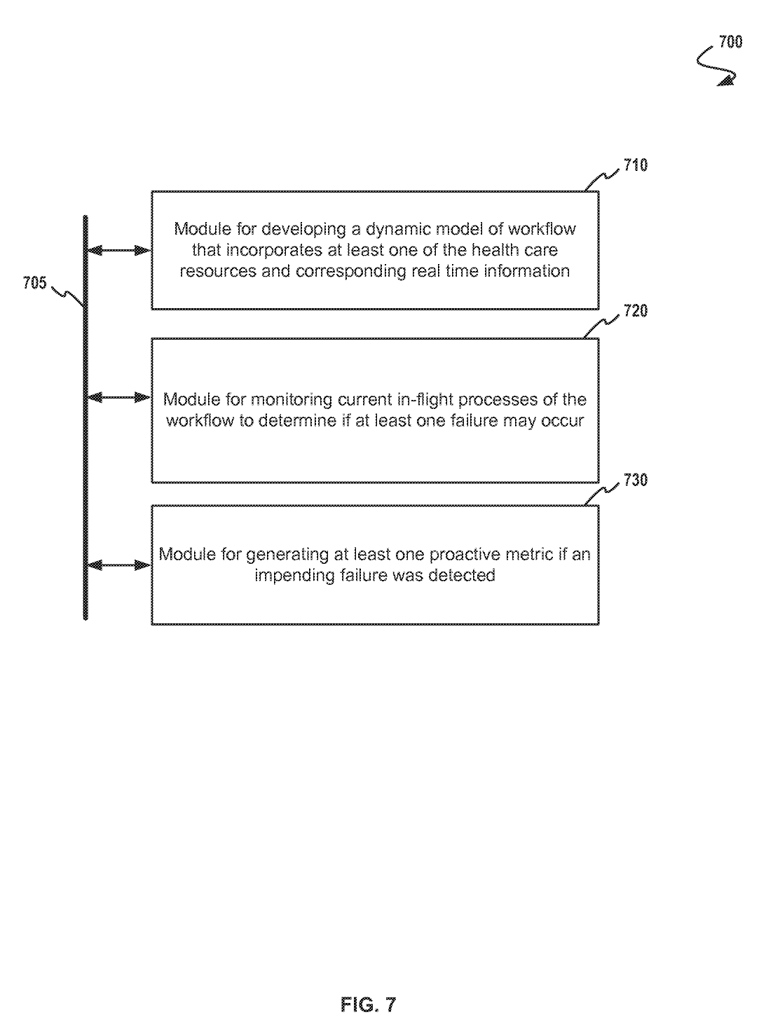

FIG. 7 depicts a block diagram of a system for modeling health information to optimize workflow. As an option, the present system 700 may be implemented in the context of the architecture and functionality of the embodiments described herein. Of course, however, the system 700 or any operation therein may be carried out in any desired environment. As shown, system 700 comprises a plurality of modules, a module comprising at least one processor and a memory, each connected to a communication link 705, and any module can communicate with other modules over communication link 705. The modules of the system can, individually or in combination, perform method steps within system 700. Any method steps performed within system 700 may be performed in any order unless as may be specified in the claims. As shown, system 700 implements a method for modeling health information to optimize workflow, the system 700 comprising modules for: developing a dynamic model of workflow that incorporates at least one of the health care resources and corresponding real time information (see module 710); monitoring current in-flight processes of the workflow to determine if at least one failure may occur (see module 720); and generating at least one proactive metric if an impending failure was detected (see module 730).

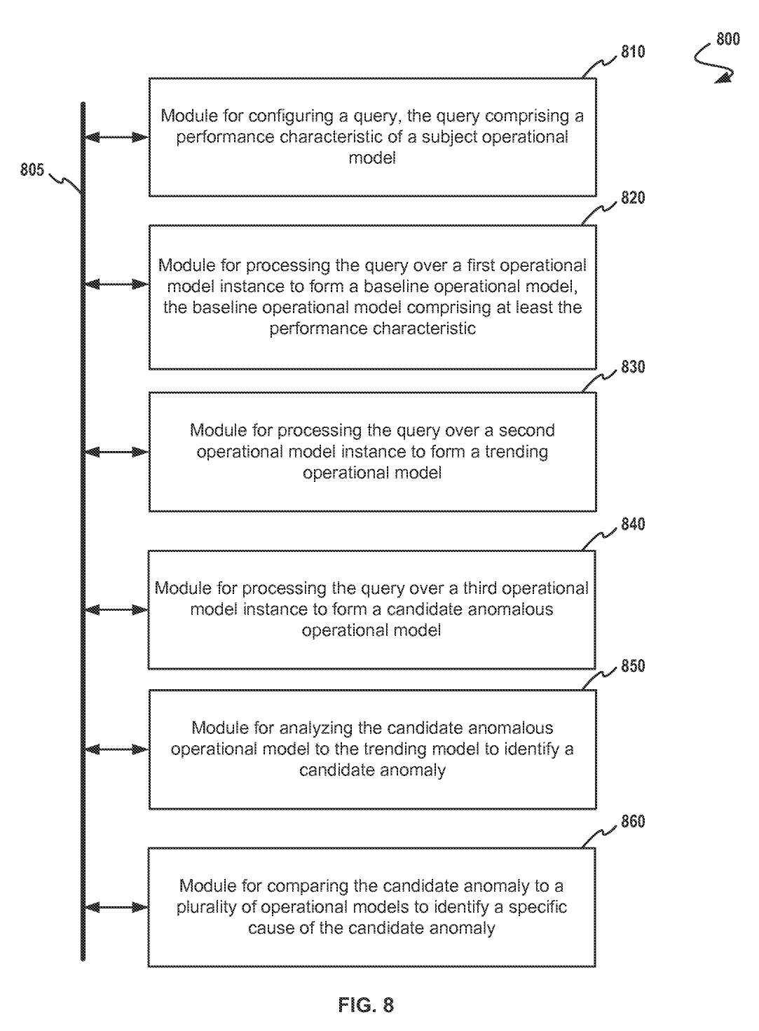

FIG. 8 depicts a block diagram of a system for analyzing health information to optimize workflows. As an option, the present system 800 may be implemented in the context of the architecture and functionality of the embodiments described herein. Of course, however, the system 800 or any operation therein may be carried out in any desired environment. As shown, system 800 comprises a plurality of modules, a module comprising at least one processor and a memory, each connected to a communication link 805, and any module can communicate with other modules over communication link 805. The modules of the system can, individually or in combination, perform method steps within system 800. Any method steps performed within system 800 may be performed in any order unless as may be specified in the claims. As shown, system 800 implements a method for analyzing health information to optimize workflow, the system 800 comprising modules for: configuring a query, the query comprising a performance characteristic of a subject operational model (see module 810); processing the query over a first operational model instance to form a baseline operational model, the baseline operational model comprising at least the performance characteristic (see module 820); processing the query over a second operational model instance to form a trending operational model (see module 830); processing the query over a third operational model instance to form a candidate anomalous operational model (see module 840); analyzing the candidate anomalous operational model to the trending model to identify a candidate anomaly (see module 850); and comparing the candidate anomaly to a plurality of operational models to identify a specific cause of the candidate anomaly (see module 860).

### Computer-Implemented Embodiments

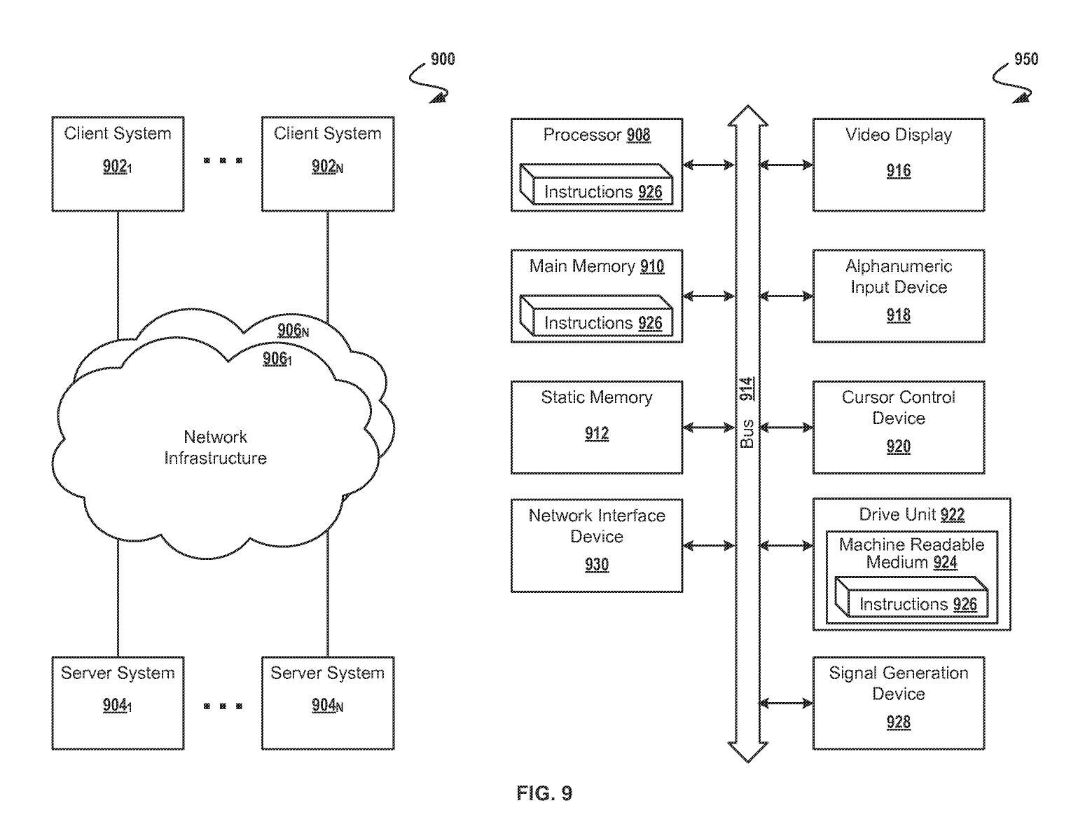

FIG. 9 is a diagrammatic representation of a network 900, including nodes for client computer systems 902₁ through 902_{N}, nodes for server computer systems 904₁ through 904_{N}, nodes for network infrastructure 906₁ through 906_{N}, any of which nodes may comprise a machine 950 within which a set of instructions for causing the machine to perform any one of the techniques discussed above may be executed. The embodiment shown is purely exemplary, and might be implemented in the context of one or more of the figures herein.

Any node of the network 900 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 950 includes a processor 908 (e.g. a processor core, a microprocessor, a computing device, etc), a main memory 910 and a static memory 912, which communicate with each other via a bus 914. The machine 950 may further include a display unit 916 that may comprise a touch-screen, or a liquid crystal display (LCD), or a light emitting diode (LED) display, or a cathode ray tube (CRT). As shown, the computer system 950 also includes a human input/output (I/O) device 918 (e.g. a keyboard, an alphanumeric keypad, etc), a pointing device 920 (e.g. a mouse, a touch screen, etc), a drive unit 922 (e.g. a disk drive unit, a CD/DVD drive, a tangible computer readable removable media drive, an SSD storage device, etc), a signal generation device 928 (e.g. a speaker, an audio output, etc), and a network interface device 930 (e.g. an Ethernet interface, a wired network interface, a wireless network interface, a propagated signal interface, etc).

The drive unit 922 includes a machine-readable medium 924 on which is stored a set of instructions (i.e. software, firmware, middleware, etc) 926 embodying any one, or all, of the methodologies described above. The set of instructions 926 is also shown to reside, completely or at least partially, within the main memory 910 and/or within the processor 908. The set of instructions 926 may further be transmitted or received via the network interface device 930 over the network bus 914.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

We claim:

1. A computer-implemented method for modeling health information to optimize workflow, the method comprising:
collecting information, in real time using a processor, from a plurality of health care resources;
developing a dynamic model of workflow that incorporates at least one of the health care resources and corresponding real time information;
monitoring, using a processor current in-flight processes of the workflow to determine if at least one failure may occur; and
generating at least one proactive metric if an impending failure was detected.
